(19) United States
(12) Patent Application Publication
(10) Pub. No.: US 2026/0196820 A1
(43) Pub. Date: Jul. 9, 2026

(54) OVERVOLTAGE PROTECTION CIRCUIT

(71) Applicant: FOXTRON VEHICLE TECHNOLOGIES CO., LTD., New Taipei City (TW)

(72) Inventor: KAI-CHU CHANG, New Taipei City (TW)

(21) Appl. No.: 19/093,274

(22) Filed: Mar. 28, 2025

(30) Foreign Application Priority Data
Jan. 6, 2025 (TW) 114100405

(51) Int. Cl. H02H 1/00; H02H 3/20

(52) U.S. Cl. CPC H02H 1/0007; H02H 3/20

(57) ABSTRACT

An overvoltage protection circuit includes a main transistor, a first resistance circuit and a second resistance circuit. The first resistance has a first resistance, and the second resistance has a second resistance. A first terminal of the main transistor is coupled to an input voltage and connected to a first terminal of the first resistance circuit. A second terminal of the main transistor is used as an output terminal of the overvoltage protection circuit. A first terminal of the second resistance circuit is connected to a second terminal of the first resistance circuit. A control node between the first terminal of the second resistance circuit and the second terminal of the first resistance circuit is connected to a control terminal of the main transistor.

### CROSS-REFERENCE TO RELATED PATENT APPLICATION

This application claims the benefit of priority to Taiwan Patent Application No. 114100405, filed on Jan. 6, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to overvoltage, and more particularly to an overvoltage protection circuit.

### BACKGROUND OF THE DISCLOSURE

Load dump, also known as load drop, refers to instantaneous disconnection of a power load. Electrical hazards from instantaneous switching of the power load need to be taken seriously. When the power load is instantaneously disconnected from a main wire, a power source, an inductive electric generator and other devices that are connected to the main wire can be damaged when a surge is generated in a voltage signal of the inductive electric generator.

In a vehicle, storage batteries are connected between a plurality of electronic control components and the inductive electric generator. The inductive electric generator is configured to charge the storage batteries. However, when a wiring harness is aged or has poor contact with the storage batteries, the storage batteries are disconnected from the electronic control components and the inductive electric generator. As a result, the surge is generated in the voltage signal of an output terminal of the inductive electric generator. A voltage of the surge of the voltage signal is maintained at a very high voltage value for a very long period of time such that the electronic control components are seriously damaged. This situation is called a load dump. A peak voltage of the surge often reaches 120V, and is maintained at 120V for 400 ms. However, a load dump protection threshold voltage is only 40V for an automotive electric system having a working voltage of 12V, and the load dump protection threshold voltage is only 60V for an automotive electric system having a working voltage of 24V.

### SUMMARY OF THE DISCLOSURE

In response to the above-referenced technical inadequacies, the present disclosure provides an overvoltage protection circuit. The overvoltage protection circuit includes a main transistor, a first resistance circuit and a second resistance circuit. A first terminal of the main transistor is coupled to an input voltage. A second terminal of the main transistor is used as an output terminal of the overvoltage protection circuit. The first resistance circuit has a first resistance. A first terminal of the first resistance circuit is connected to the first terminal of the main transistor. The second resistance circuit has a second resistance. A first terminal of the second resistance circuit is connected to a second terminal of the first resistance circuit. A second terminal of the second resistance circuit is coupled to a reference voltage level. A control node between the first terminal of the second resistance circuit and the second terminal of the first resistance circuit is connected to a control terminal of the main transistor.

As described above, the present disclosure provides the overvoltage protection circuit. When a surge or an instantaneous high voltage value is generated in an output voltage of a circuit component inside a vehicle due to load dump, coupling between a plurality of wires of a wiring harness of an input power source, a surge in a power grid, lightning strike or other conditions in various applications, the output voltage of the overvoltage protection circuit of the present disclosure is clamped instantly. Therefore, the circuit component of the vehicle is not increased to be higher than its rated voltage, thereby preventing the circuit component from being damaged. Furthermore, an inductor having a large inductance, a surge protection device (SPD) and a transient voltage suppressor (TVS) are included in a conventional overvoltage protection circuit, but not included in the overvoltage protection circuit of the present disclosure. Therefore, heat that is generated by the overvoltage protection circuit of the present disclosure and an area of a space occupied by the overvoltage protection circuit of the present disclosure are much less than that of the conventional overvoltage protection circuit.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit diagram of an overvoltage protection circuit according to a first embodiment of the present disclosure;

FIG. 2 is a circuit diagram of an overvoltage protection circuit according to a second embodiment of the present disclosure;

FIG. 3 is a circuit diagram of an overvoltage protection circuit according to a third embodiment of the present disclosure;

FIG. 4 is a circuit diagram of an overvoltage protection circuit according to a fourth embodiment of the present disclosure;

FIG. 5 is a circuit diagram of an overvoltage protection circuit according to a fifth embodiment of the present disclosure;

FIG. 6 is a circuit diagram of an overvoltage protection circuit according to a sixth embodiment of the present disclosure;

FIG. 7 is a circuit diagram of an overvoltage protection circuit according to a seventh embodiment of the present disclosure;

FIG. 8 is a circuit diagram of a bias circuit of an overvoltage protection circuit according to an eighth embodiment of the present disclosure;

FIG. 9 is a circuit diagram of a bandgap reference circuit of an overvoltage protection circuit according to a ninth embodiment of the present disclosure;

FIG. 10 is a circuit diagram of a comparator of an overvoltage protection circuit according to a tenth embodiment of the present disclosure;

FIG. 11 is a waveform diagram of signals of the overvoltage protection circuit according to the first to tenth embodiments of the present disclosure; and

FIG. 12 is a waveform diagram of signals of the overvoltage protection circuit according to the first to tenth embodiments of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

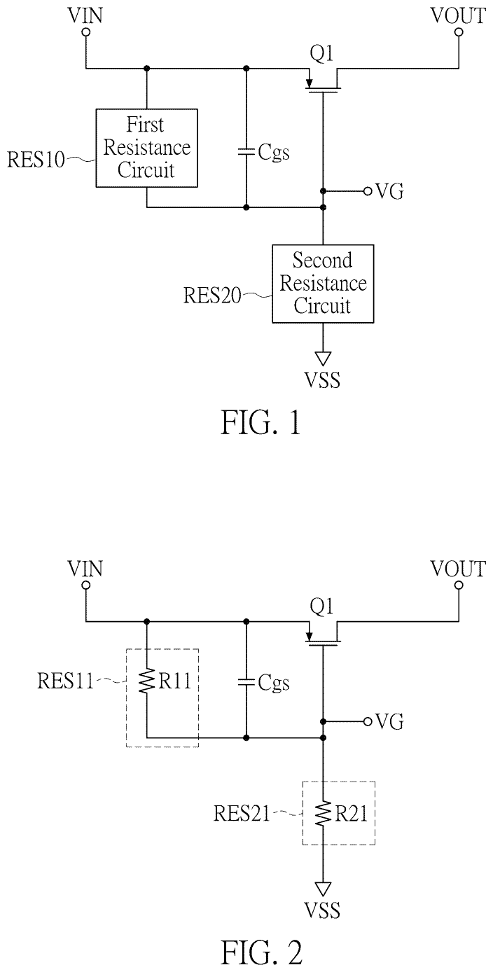

Reference is made to FIG. 1, which is a circuit diagram of an overvoltage protection circuit according to a first embodiment of the present disclosure.

As shown in FIG. 1, in the first embodiment, the overvoltage protection circuit of the present disclosure includes a main transistor Q1, a first resistance circuit RES10 and a second resistance circuit RES20.

A first terminal (such as a source terminal) of the main transistor Q1 is coupled to an input voltage VIN. A second terminal (such as a drain terminal) of the main transistor Q1 is connected to an output terminal of the overvoltage protection circuit of the present disclosure. A voltage of the second terminal of the main transistor Q1 is used as an output voltage VOUT of the overvoltage protection circuit of the present disclosure.

It is worth noting that, the first resistance circuit RES10 and the second resistance circuit RES20 are connected between the input voltage VIN and a reference voltage level VSS. The first resistance circuit RES10 is connected in parallel to a parasitic capacitor Cgs of the main transistor Q1.

The first resistance circuit RES10 has a first resistance, and the first resistance may be a fixed resistance or a variable resistance. The first resistance circuit RES10 includes one or more circuit components. The first resistance of the first resistance circuit RES10 is a sum of resistances of the one or more circuit components.

The second resistance circuit RES20 has a second resistance, and the second resistance may be a fixed resistance or a variable resistance. The second resistance circuit RES20 includes one or more circuit components. The second resistance of the second resistance circuit RES20 is a sum of resistances of the one or more circuit components. The second resistance of the second resistance circuit RES20 is different from the first resistance of the first resistance circuit RES10.

A first terminal of the first resistance circuit RES10 is connected to an input node between the first terminal of the main transistor Q1 and the input voltage VIN, or is connected to the input node between the first terminal of the main transistor Q1 and an input power source used to supply the input voltage VIN. A first terminal of the second resistance circuit RES20 is connected to a second terminal of the first resistance circuit RES10. A second terminal of the second resistance circuit RES20 is coupled to the reference voltage level VSS.

A control node between the first terminal of the second resistance circuit RES20 and the second terminal of the first resistance circuit RES10 is connected to a control terminal (such as a gain terminal) of the main transistor Q1. A voltage of the control node is inputted to the control terminal of the main transistor Q1 as a voltage VG of the control terminal of the main transistor Q1.

That is, the overvoltage protection circuit of the present disclosure includes the first resistance circuit RES10 and the second resistance circuit RES20 that are configured for the main transistor Q1. In the overvoltage protection circuit of the present disclosure, the first resistance of the first resistance circuit RES10 and the second resistance of the second resistance circuit RES20 are set or adjusted for appropriately setting an equivalent impedance of a parallel circuit in which the first resistance circuit RES10 is connected in parallel to the parasitic capacitance Cgs and for appropriately setting a ratio of the second resistance to a sum of the first resistance and the second resistance. As a result, the voltage VG of the control terminal (such as the gain terminal) of the main transistor Q1 are appropriately controlled or adjusted. Before the voltage of the second terminal of the main transistor Q1 that is used as the output voltage VOUT of the overvoltage protection circuit of the present disclosure is increased to an excessive voltage value, the output voltage VOUT is clamped to be equal to or smaller than working voltages or rated voltages of the overvoltage protection circuit of the present disclosure and a post-stage circuit such as a load. Therefore, the overvoltage protection circuit of the present disclosure and the post-stage circuit connected thereto are prevented from being damaged due to overvoltage.

Reference is made to FIG. 2, which is a circuit diagram of an overvoltage protection circuit according to a second embodiment of the present disclosure.

As shown in FIG. 2, in the second embodiment, the overvoltage protection circuit of the present disclosure includes the main transistor Q1, a first resistance circuit RES11 and a second resistance circuit RES21.

As shown in FIG. 2, the first resistance circuit RES11 includes a resistor R11, and the first resistance of the first resistance circuit RES11 includes a resistance of the resistor R11. In practice, the first resistance circuit RES11 may include a plurality of resistors that are connected with each other in series or in parallel and have the same resistance or different resistances, and the first resistance of the first resistance circuit RES11 may include a total resistance of a circuit in which the plurality of resistors are connected with each other in series or in parallel.

As shown in FIG. 2, the second resistance circuit RES21 includes a resistor R2, and the second resistance of the second resistance circuit RES21 includes a resistance of the resistor R21. In practice, the second resistance circuit RES21 may include a plurality of resistors that are connected with each other in series or in parallel and have the same resistance or different resistances, and the second resistance of the second resistance circuit RES21 may include a total resistance of a circuit in which the plurality of resistors are connected with each other in series or in parallel.

A first terminal of the resistor R11 is coupled to the input voltage VIN. A second terminal of the resistor R11 is connected to a first terminal of the resistor R21. A second terminal of the resistor R21 is coupled to the reference voltage level VSS. The control node between the second terminal of the resistor R11 and the first terminal of the resistor R21 is connected to the control terminal of the main transistor Q1.

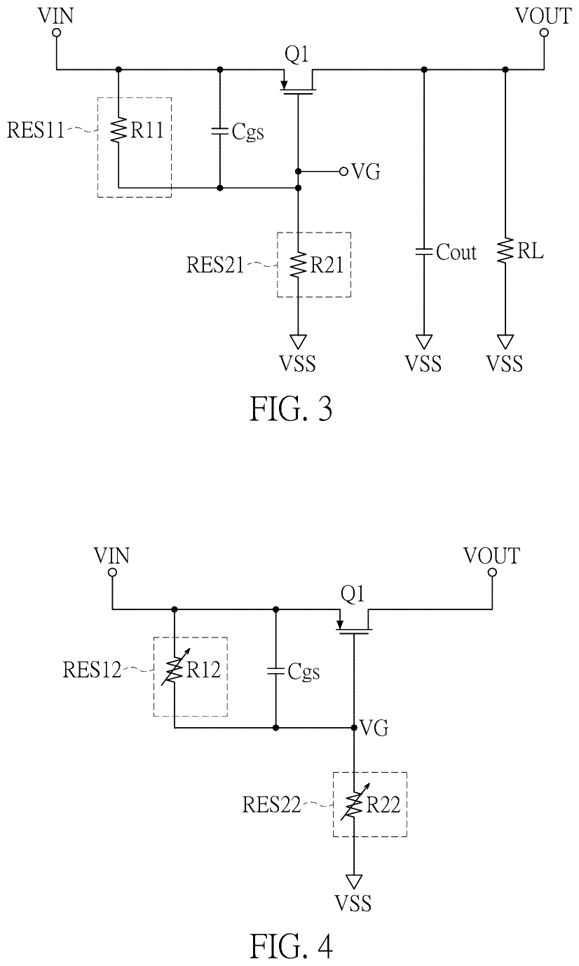

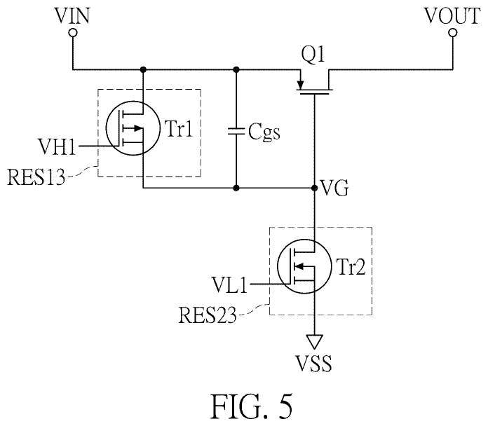

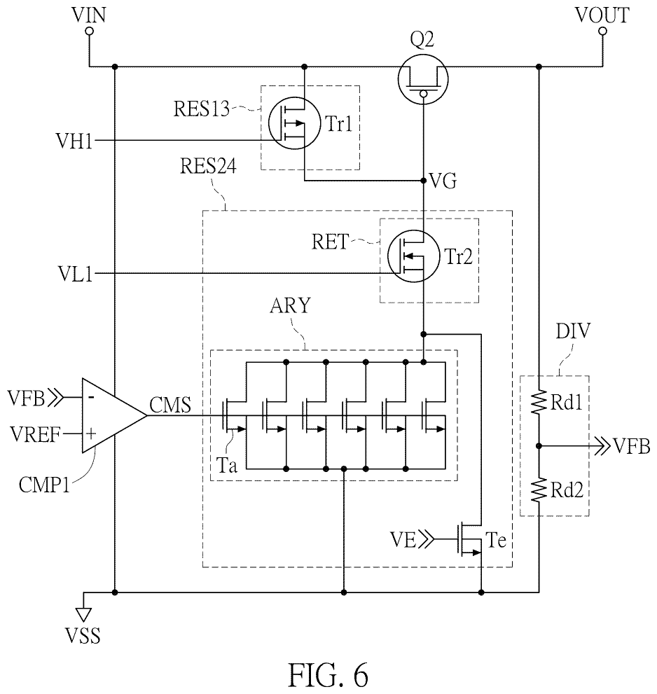

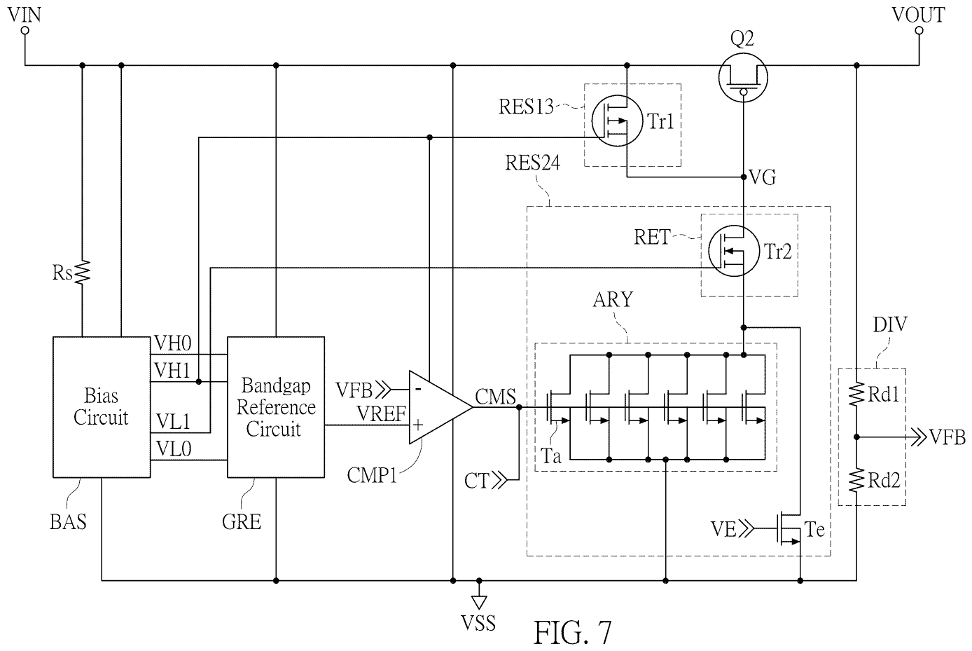

In time domain, the voltage VG of the control terminal of the main transistor Q1 is represented by an equation of:

$$VG ( t ) = VIN \times ( δ ( t ) - 1 / Cgs \times R 2 \times e \hat{} - ( ( R 1 + R 2 ) / ( Cgs \times R 1 \times R 2 ) ) t ) ,$$

in which VG represents the voltage of the control terminal of the main transistor Q1 shown in FIG. 1 to FIG. 5 or a voltage of a control terminal of a main transistor Q2 shown in FIG. 6 and FIG. 7, VIN represents the input voltage, Cgs represents a capacitance of the parasitic capacitor Cgs of the main transistor Q1 or Q2, R1 represents the first resistance of the first resistance circuit RES10 shown in FIG. 1, the first resistance circuit RES11 shown in FIG. 2 and FIG. 3, the first resistance circuit RES12 shown in FIG. 4, or the first resistance circuit RES13 shown in FIG. 5 to FIG. 7, and R2 represents the second resistance of the second resistance circuit RES20 shown in FIG. 1, the second resistance circuit RES21 shown in FIG. 2 and FIG. 3, the second resistance circuit RES22 shown in FIG. 4, the second resistance circuit RES23 shown in FIG. 5, or the second resistance circuit RES24 shown in FIG. 6 and FIG. 7.

When a surge is generated in the output voltage VOUT of the second terminal of the main transistor Q1, the voltage VG of the control terminal of the main transistor Q1 is calculated by an equation of:

$$VG = VIN [ 1 - ( 1 / Cgs \times R 2 ) ] .$$

When VIN×(1/Cgs×R2)<|Vth|, the main transistor Q1 is turned off.

An off-time of the main transistor Q1 is changed with a change in the second resistance of the second resistance circuit RES21, or is changed with a change in an equivalent impedance of a parallel circuit in which the first resistance of the first resistance circuit RES11 is connected in parallel to the parasitic capacitor Cgs of the main transistor Q1. In particular, when the surge is generated in the output voltage VOUT of the second terminal of the main transistor Q1, the main transistor Q1 is instantaneously turned off for clamping the output voltage VOUT of the overvoltage protection circuit of the present disclosure. Therefore, the output voltage VOUT of the overvoltage protection circuit of the present disclosure is not increased to the excessive voltage value, thereby preventing the overvoltage protection circuit of the present disclosure and the post-stage circuit connected thereto from being damaged due to overvoltage.

Reference is made to FIG. 3, which is a circuit diagram of an overvoltage protection circuit according to a third embodiment of the present disclosure.

The descriptions of the third embodiment that are the same as the descriptions of the second embodiment are not repeated herein.

A difference between the third and second embodiments is that, as shown in FIG. 3, the overvoltage protection circuit of the third A first terminal of the output capacitor Cout is connected to the second terminal of the main transistor Q1, and a second terminal of the output capacitor Cout is coupled to the reference voltage level VSS.

The second terminal of the main transistor Q1 or the output capacitor Cout is used as the output terminal of the overvoltage protection circuit of the present disclosure, and is connected to a first terminal of a load RL. A second terminal of the load RL may be coupled to the reference voltage level VSS.

When the main transistor Q1 is turned off, the smaller the resistance of the load RL and the capacitance of the output capacitor Cout are, the faster the output voltage VOUT of the overvoltage protection circuit of the present disclosure is reduced.

When the main transistor Q1 is turned off, the larger the resistance of the load RL and the capacitance of the output capacitor Cout are, the slower the output voltage VOUT of the overvoltage protection circuit of the present disclosure is reduced.

Conversely, when the main transistor Q1 is turned on, the smaller the on-resistance between the first terminal (such as the source terminal) and the second terminal (such as the drain terminal) of the main transistor Q1 and the capacitance of the output capacitor Cout are and the larger the resistance of the load RL is, the faster the output voltage VOUT of the overvoltage protection circuit of the present disclosure is increased. Therefore, the main transistor Q1 is switched between an on-state and an off-state for controlling the output voltage VOUT of the overvoltage protection circuit of the present disclosure to stably fall within a working voltage range thereof.

A transition in the load RL is unpredictable. Therefore, a switching speed of the main transistor Q1, the capacitance of the output capacitor Cout and the on-resistance between the first terminal (such as the source terminal) and the second terminal (such as the drain terminal) of the main transistor Q1 must be appropriately selected. For example, the overvoltage protection circuit of the present disclosure may include the output capacitor Cout having the large capacitance and the main transistor Q1 having a small on-resistance for slowly switching the main transistor Q1 and reducing ripple waves in the output voltage VOUT of the overvoltage protection circuit of the present disclosure.

In practice, the output capacitor Cout and the load RL as shown in FIG. 3 may also be included in the overvoltage protection circuit shown FIG. 1, FIG. 2 and FIG. 4 to FIG. 7 in the same configuration as that shown in FIG. 3.

Reference is made to FIG. 4, which is a circuit diagram of an overvoltage protection circuit according to a fourth embodiment of the present disclosure.

As shown in FIG. 4, in the fourth embodiment, the overvoltage protection circuit of the present disclosure includes the main transistor Q1, a first resistance circuit RES12 and a second resistance circuit RES22.

As shown in FIG. 2 and FIG. 3, in the second and third embodiments, the resistor R11 included in the first resistance circuit RES11 and the resistor R12 included in the second resistance circuit RES21 are fixed resistors each having the fixed resistance.

In contrast, as shown in FIG. 4, in the fourth embodiment, the resistor R12 included in the first resistance circuit RES12 and the resistor R22 included in the second resistance circuit RES22 are variable resistors each having a variable resistance.

In practice, one of the resistances R11 and R12 may be a fixed resistor, and the other of the resistances R11 and R12 may be a variable resistor.

In the overvoltage protection circuit of the fourth embodiment of the present disclosure, by adjusting the first resistance of the first resistance circuit RES12 and/or the second resistance of the second resistance circuit RES22, the voltage VG of the control terminal of the main transistor Q1 is modulated so as to appropriately control an operational state of the main transistor Q1. As a result, the voltage of the second terminal of the main transistor Q1 (that is used as the output voltage VOUT of the overvoltage protection circuit of the present disclosure) is maintained within the working voltage ranges of the overvoltage protection circuit of the present disclosure and the post-stage circuit thereof.

Reference is made to FIG. 5, which is a circuit diagram of an overvoltage protection circuit according to a fifth embodiment of the present disclosure.

As shown in FIG. 5, in the fifth embodiment, the overvoltage protection circuit of the present disclosure includes the main transistor Q1, a first resistance circuit RES13, and a second resistance circuit RES23.

The first resistance circuit RES13 includes a transistor as a first transistor Tr1. The first resistance circuit RES13 has the first resistance. The first resistance of the first resistance circuit RES13 includes an internal resistance of the first transistor Tr1.

The second resistance circuit RES23 includes a transistor as a control-side transistor Tr2. The second resistance circuit RES23 has the second resistance. The second resistance of the second resistance circuit RES23 includes an internal resistance of the control-side transistor Tr2.

A first terminal of the first transistor Tr1 is connected to the input node between the first terminal of the main transistor Q1 and the input voltage VIN. The control node between a second terminal of the first transistor Tr1 and a first terminal of the control-side transistor Tr2 is connected to the control terminal of the main transistor Q1. The voltage VG is at the control terminal of the main transistor Q1.

A control terminal of the first transistor Tr1 is coupled to a first high-side bias voltage VH1. A control terminal of the control-side transistor Tr2 is coupled to a first low-side bias voltage VL1. The first high-side bias voltage VH1 and the first low-side bias voltage VL1 may be variable voltages.

In the overvoltage protection circuit of the fifth embodiment of the present disclosure, the first high-side bias voltage VH1 to which the control terminal of the first transistor Tr1 is coupled is appropriately set for controlling an operation state of the first transistor Tr1, and/or the first low-side bias voltage VL1 to which the control terminal of the first transistor Tr2 is coupled is appropriately set for controlling an operation state of the control-side transistor Tr2. As a result, the first resistance of the first resistance circuit RES13 and the second resistance of the second resistance circuit RES23 are set appropriately for controlling the voltage VG of the control terminal of the main transistor Q1. Therefore, the voltage of the second terminal of the main transistor Q1 (that is used as the output voltage VOUT of the overvoltage protection circuit of the present disclosure) is maintained within the working voltage ranges of the overvoltage protection circuit of the present disclosure and the post-stage circuit thereof.

Reference is made to FIG. 6, which is a circuit diagram of an overvoltage protection circuit according to a sixth embodiment of the present disclosure.

As shown in FIG. 6, in the sixth embodiment, the overvoltage protection circuit of the present disclosure includes the main transistor Q1, the first resistance circuit RES13, a second resistance circuit RES24, a comparator CMP1 and a voltage dividing circuit DIV. In practice, the voltage dividing circuit DIV may be omitted.

It is worth noting that, in the overvoltage protection circuit of the sixth embodiment of the present disclosure, the second resistance circuit RES24 includes a resistance component RET, a transistor circuit ARY and a bypass switch Te. In practice, the resistance component RET may be omitted, or more resistance component may be disposed.

A first terminal of the first transistor Tr1 is connected to an input node between a first terminal of the main transistor Q2 and the input voltage VIN. A control terminal of the first transistor Tr1 is coupled to the first high-side bias voltage VH1.

The resistance component RET includes one or more circuit components having resistances. For example, as shown in FIG. 6, the resistance component RET includes the control-side transistor Tr2. The first terminal of the control-side transistor Tr2 is connected to the second terminal of the first transistor Tr1. The control terminal of the control-side transistor Tr2 is coupled to the first low-side bias voltage VL1. In practice, the control-side transistor Tr2 may be replaced with the resistor R21 shown in FIG. 2, the resistor R22 shown in FIG. 4 or other circuit components having resistances.

The control terminal of the main transistor Q2 is connected to the control node between the first terminal of the control-side transistor Tr2 and the second terminal of the first transistor Tr1.

The transistor circuit ARY includes a plurality of transistors as a plurality of array transistors Ta. In practice, the transistor circuit ARY may only include one transistor. In practice, the number and types of the array transistors Ta depend on practical application requirements, and the present disclosure is not limited thereto.

A first terminal of each of the plurality of array transistors Ta is connected to a second terminal of the control-side transistor Tr2. A second terminal of each of the plurality of array transistors Ta is coupled to the reference voltage level VSS. A control terminal of each of the plurality of array transistors Ta is connected to an output terminal of the comparator CMP1 as shown in FIG. 6, or is coupled to a switching control voltage in practice.

The bypass switch Te may be a transistor. A first terminal of the bypass switch Te is connected to the second terminal of the control-side transistor Tr2 and the first terminal of each of the plurality of array transistors Ta. A second terminal of the bypass switch Te is coupled to the reference voltage level VSS. A control terminal of the bypass switch Te is coupled to a variable instruction voltage VE as shown in FIG. 6, or is coupled to an external control circuit and receives the variable instruction voltage VE from the external control circuit in practice.

The voltage dividing circuit DIV includes a first voltage dividing resistor Rd1 and a second voltage dividing resistor Rd2. A first terminal of the first voltage dividing resistor Rd1 is connected to a second terminal of the main transistor Q2 (that is used as the output terminal of the overvoltage protection circuit of the present disclosure). A second terminal of the first voltage dividing resistor Rd1 is connected to a first terminal of the second voltage dividing resistor Rd2. A second terminal of the second voltage dividing resistor Rd2 is coupled to the reference voltage level VSS.

As shown in FIG. 6, a first input terminal such as an inverting input terminal of the comparator CMP1 is connected to a feedback node between the second terminal of the first voltage dividing resistor Rd1 and the first terminal of the second voltage dividing resistor Rd2, and obtains a feedback voltage VFB from the feedback node. In practice, if the voltage dividing circuit DIV is omitted, the first input terminal of the comparator CMP1 may be directly connected to the second terminal of the main transistor Q2 (that is used as the output terminal of the overvoltage protection circuit of the present disclosure), and obtains the output voltage VOUT of the second terminal of the main transistor Q2.

A second input terminal such as a non-inverting input terminal of the comparator CMP1 may be coupled to a reference voltage VREF. An output terminal of the comparator CMP1 is connected to the control terminal of each of the plurality of array transistors Ta. The comparator CMP1 compares the feedback voltage VFB with the reference voltage VREF to determine a level of a comparing signal CMS, and outputs the comparing signal CMS to the control terminal of each of the plurality of array transistors Ta.

The higher the output voltage VOUT of the overvoltage protection circuit of the present disclosure is, the higher the feedback voltage VFB that is a divided voltage of the output voltage VOUT is.

When the feedback voltage VFB is not higher than the reference voltage VREF, an overvoltage event does not occur in the overvoltage protection circuit of the present disclosure and thus an overvoltage protection operation is not performed. At this time, the comparator CMP1 outputs the comparing signal CMS having a first level such as a high level to the control terminal of each of the plurality of array transistors Ta for turning on the plurality of array transistors Ta of the transistor circuit ARY. At the same time, the control terminal of the control-side transistor Tr2 included in the resistance component RET receives the first high-side bias voltage VH1 having the first level such as the high level such that the control-side transistor Tr2 is turned on. At the same time, the control terminal of the bypass switch Te receives the variable instruction voltage VE having the first level, such as the high level, such that the bypass switch Te is turned on, thereby reducing power leakage of the overvoltage protection circuit of the present disclosure.

It is worth noting that, when the voltage of the second terminal of the main transistor Q2 (that is used as the output terminal of the overvoltage protection circuit of the present disclosure) is too high such that the feedback voltage VFB is higher than the reference voltage VREF, the overvoltage event occurs in the overvoltage protection circuit. Under this condition, the overvoltage protection operation must be performed.

In the frequency domain, the voltage of the control terminal of the main transistor Q1 shown in FIG. 1 to FIG. 5 or the main transistor Q2 shown in FIG. 6 and FIG. 7, is calculated by equations of:

$$VG = VIN \times ( ( S \times Cgs \times R 1 \times R 2 + R 2 ) / ( S \times Cgs \times R 1 \times R 2 + R 1 + R 2 ) ) ,$$

and

$$S = j \times ω = j \times 2 \times π \times f ,$$

in which VG represents the voltage of the control terminal of the main transistor Q2 or Q1, VIN represents the input voltage, f represents a frequency of a waveform of a signal of the input voltage VIN, Cgs represents a parasitic capacitor of the main transistor Q2 or Q1, R1 represents the first resistance of the first resistance circuit RES10 shown in FIG. 1, the first resistance circuit RES11 shown in FIG. 2 and FIG. 3, the first resistance circuit RES12 shown in FIG. 4 or the first resistance circuit RES13 shown in FIG. 5 to FIG. 7, and R2 represents the second resistance of the second resistance circuit RES20 shown in FIG. 1, the second resistance circuit RES21 shown in FIG. 2 and FIG. 3, the second resistance circuit RES22 shown in FIG. 4, the second resistance circuit RES23 shown in FIG. 5 or the second resistance circuit RES24 shown in FIG. 6 and FIG. 7.

The higher the frequency of the input voltage VIN is, the smaller the parameter S multiplied by the capacitance of the parasitic capacitor Cgs of the main transistor Q2 is, and the smaller the equivalent impedance of the parallel circuit in which the parasitic capacitor Cgs of the main transistor Q2 is connected in parallel to the first resistance circuit RES10, RES11, RES12 or RES13 is.

The smaller the equivalent impedance of the parallel circuit in which the parasitic capacitor Cgs of the main transistor Q2 is connected in parallel to the first resistance circuit RES10, RES11, RES12 or RES13 is, the smaller the voltage difference between the voltage VG of the control terminal of the main transistor Q2 and the input voltage VIN is.

The voltage difference between the voltage VG of the control terminal of the main transistor Q2 and the input voltage VIN is reduced to be lower than an absolute value of a threshold voltage of the main transistor Q2, which is represented by VIN−VG<|Vth|, in which Vth represents the threshold voltage of the main transistor Q2. Under this condition, the main transistor Q2 is turned off.

In the overvoltage protection operation, a ratio of the second resistance of the second resistance circuit RES24 to a sum of the first resistance of the first resistance circuit RES13 and the second resistance of the second resistance circuit RES24 is increased for increasing the voltage VG of the control terminal of the main transistor Q1 to realize VIN−VG<|Vth| as described above. As a result, the main transistor Q2 is turned off.

When the output voltage VOUT of the overvoltage protection circuit of the present disclosure is too high such that the feedback voltage VFB that is the divided voltage of the output voltage VOUT is higher than the reference voltage VREF, the overvoltage event will occur or has occurred. Under this condition, the overvoltage protection operation must be performed. At this time, the control terminal of the bypass switch Te receives the variable instruction voltage VE at an initial voltage level such as a low voltage level such that the bypass switch Te is turned off. At the same time, the control terminal of the control-side transistor Tr2 included in the resistance component RET receives the first high-side bias voltage VH1 at the initial voltage level such as the low voltage level such that the control-side transistor Tr2 is turned off. At the same time, the comparator CMP1 outputs the comparing signal CMS at the initial voltage level such as the low voltage level to the control terminal of each of the plurality of array transistors Ta for turning off the plurality of array transistors Ta of the transistor circuit ARY. The voltage difference between the voltage VG of the control terminal of the main transistor Q2 and the input voltage VIN is lower than the absolute value of the threshold voltage of the main transistor Q2, which is represented by VIN−VG<|Vth|. At this time, the main transistor Q2 is turned off. As a result, the voltage of the second terminal of the main transistor Q2 (that is used as the output terminal of the overvoltage protection circuit of the present disclosure) is not increased to the excessive voltage value. The overvoltage protection circuit and the post-stage circuit connected thereto are prevented from being damaged due to overvoltage.

Reference is made to FIG. 7, which is a circuit diagram of an overvoltage protection circuit according to a seventh embodiment of the present disclosure.

The descriptions of the seventh embodiment of the present disclosure that are the same as the descriptions of the sixth embodiment of the present disclosure are not repeated herein.

A difference between the seventh and sixth embodiments of the present disclosure is that, the overvoltage protection circuit of the seventh embodiment of the present disclosure further includes a bias circuit BAS, a bandgap reference circuit GRE and a resistor Rs.

An input terminal of the bias circuit BAS may be coupled to the input voltage VIN, and/or coupled to the input voltage VIN through the resistor Rs.

A second output terminal of the bias circuit BAS is connected to the control terminal of the first transistor Tr1. The bias circuit BAS sets and modulates the first high-side bias voltage VH1. The second output terminal of the bias circuit BAS outputs the first high-side bias voltage VH1 to the control terminal of the first transistor Tr1.

A third output terminal of the bias circuit BAS is connected to the control terminal of the control-side transistor Tr2. The bias circuit BAS sets and modulates the first low-side bias voltage VL1. The third output terminal of the bias circuit BAS outputs the first low-side bias voltage VL1 to the control terminal of the control-side transistor Tr2.

A first output terminal, the second output terminal and a fourth output terminal of the bias circuit BAS are connected to an input terminal of the bandgap reference circuit GRE. The first output terminal of the bias circuit BAS outputs an initial high-side bias voltage VH0 to the bandgap reference circuit GRE. The second output terminal of the bias circuit BAS outputs the first high-side bias voltage VH1 to the bandgap reference circuit GRE. The fourth output terminal of the bias circuit BAS outputs an initial low-side bias voltage VL0 to the bandgap reference circuit GRE.

An output terminal of the bandgap reference circuit GRE is connected to the second input terminal such as the non-inverting input terminal of the comparator CMP1. The bandgap reference circuit GRE sets the reference voltage VREF according to the initial high-side bias voltage VH0, the first high-side bias voltage VH1 and the initial low-side bias voltage VL0 from the bias circuit BAS. The bandgap reference circuit GRE outputs the reference voltage VREF to the second input terminal such as the non-inverting input terminal of the comparator CMP1.

If necessary, the control terminal of each of the plurality of array transistors Ta may be coupled to a variable switching voltage CT as shown in FIG. 7, or may be connected to the external control circuit and receives the variable switching voltage CT from the external control circuit. Each of the plurality of array transistors Ta may be switched by the variable switching voltage CT.

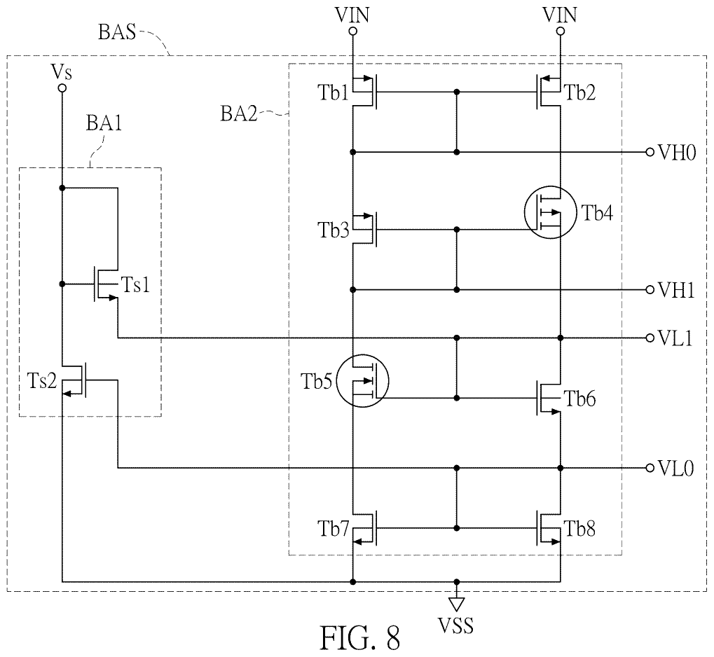

Reference is made to FIG. 8, which is a circuit diagram of a bias circuit of an overvoltage protection circuit according to an eighth embodiment of the present disclosure.

The overvoltage protection circuit of the present disclosure may include the bias circuit BAS shown in FIG. 8. The bias circuit BAS shown in FIG. 7 may be replaced with the bias circuit BAS shown in FIG. 8.

As shown in FIG. 8, the bias circuit BAS includes a bias startup circuit BA1 and a bias supply circuit BA2.

The bias startup circuit BA1 includes a first startup transistor Ts1 and a second startup transistor Ts2. The bias supply circuit BA2 includes a first bias transistor Tb1, a second bias transistor Tb2, a third bias transistor Tb3, a fourth bias transistor Tb4, a fifth bias transistor Tb5, a sixth bias transistor Tb6, a seventh bias transistor Tb7 and an eighth bias transistor Tb8.

A first terminal of the resistor Rs is coupled to the input voltage VIN. A first terminal and a control terminal of the first startup transistor Ts1 are connected to a second terminal of the resistor Rs, and receive a voltage Vs from the second terminal of the resistor Rs. The resistor Rs may have a large resistance for protection of the bias startup circuit BA1. A first terminal of the second startup transistor Ts2 is connected to the first terminal and the control terminal of the first startup transistor Ts1. A second terminal of the second startup transistor Ts2 is coupled to the reference voltage level VSS.

A first terminal of the first bias transistor Tb1 and a first terminal of the second bias transistor Tb2 are coupled to the input voltage VIN. A first terminal of the third bias transistor Tb3, a second terminal and a control terminal of the first bias transistor Tb1 and a control terminal of the second bias transistor Tb2 are connected to an initial high-side bias node having the initial high-side bias voltage VH0.

A first terminal of the fourth bias transistor Tb4 is connected to a second terminal of the second bias transistor Tb2. A first terminal of the fifth bias transistor Tb5, a second terminal and a control terminal of the third bias transistor Tb3 and a control terminal of the fourth bias transistor Tb4 are connected to a first high-side bias node having the first high-side bias voltage VH1.

A first terminal and a control terminal of the sixth bias transistor Tb6, a control terminal of the fifth bias transistor Tb5 and a second terminal of the first startup transistor Ts1 are connected to a first low-side bias node having the first low-side bias voltage VL1.

A first terminal of the seventh bias transistor Tb7 is connected to a second terminal of the fifth bias transistor Tb5. A second terminal of the seventh bias transistor Tb7 and a second terminal of the eighth bias transistor Tb8 are coupled to the reference voltage level VSS. A first terminal and a control terminal of the eighth bias transistor Tb8, a second terminal of the sixth bias transistor Tb6, a control terminal of the seventh bias transistor Tb7 and a control terminal of the second startup transistor Ts2 are connected to an initial low-side bias node having the initial low-side bias voltage VL0.

A first input current flows from the input voltage VIN shown in FIG. 7 through the resistor Rs into the bias circuit BAS shown in FIG. 7 and FIG. 8. Inside the bias circuit BAS shown in FIG. 8, the first input current flows through the first transistor Tr, such that the first transistor Tr is turned on. Then, the first input current flows through the sixth bias transistor Tb6. Then, a part of the first input current flows to the control terminal of the second startup transistor Ts2. At the same time, the second bias transistor Tb2 and the fourth bias transistor Tb4 are continually turned on. A second input current flows from the input voltage VIN sequentially through the second bias transistor Tb2 and the fourth bias transistor Tb4 to the sixth bias transistor Tb6. Then, a part of the second input current flows to the control terminal of the second startup transistor Ts2.

When the initial low-side bias voltage VL0 at the initial low-side bias node between the second terminal of the sixth bias transistor Tb6 and the first terminal of the eighth bias transistor Tb8 is gradually increased to be higher than a voltage difference between the control terminal and the second terminal of the second startup transistor Ts2, the second startup transistor Ts2 is switched from an off-state to an on-state. At this time, the resistor Rs receives a part of the input voltage VIN, thereby preventing the first startup transistor Ts1 and the second startup transistor Ts2 inside the bias circuit BAS from being damaged by excessive voltages being higher than their rated voltages.

For example, the control terminal and the second terminal of the second startup transistor Ts2 may respectively be a gain terminal and a source terminal. The voltage difference between the gate terminal and the source terminal of the second startup transistor Ts2 is calculated by an equation of:

$$VGS = VG - VS ,$$

in which VGS represents the voltage difference between the gate terminal and the source terminal of the second startup transistor Ts2, VG represents a voltage of the gate terminal of the second startup transistor Ts2, and VS represents a voltage of the source terminal of the second startup transistor Ts2.

As shown in FIG. 8, the bias startup circuit BA1 is configured to start up the bias supply circuit BA2.

When the bias supply circuit BA2 is started up, the bias supply circuit BA2 shown in FIG. 8 supplies the first high-side bias voltage VH1 having an appropriate voltage value to the control terminal of the first startup transistor Ts1 shown in FIG. 7 and the bandgap reference circuit GRE shown in FIG. 7. At the same time, the bias supply circuit BA2 shown in FIG. 8 supplies the first low-side bias voltage VL1 having an appropriate voltage value to the control terminal of the second startup transistor Ts2 shown in FIG. 7. At the same time, the bias supply circuit BA2 shown in FIG. 8 supplies the initial high-side bias voltage VH0 and the initial low-side bias voltage VL0 that have appropriate voltage values to the bandgap reference circuit GRE.

For example, the initial high-side bias voltage VH0 may be equal to the input voltage VIN from which a first voltage difference (such as 1V) is subtracted, and the first high-side bias voltage VH1 may be equal to first high-side bias voltage VH1 from which a second voltage difference (such as 2V) is subtracted. The second voltage difference is higher than the first voltage difference. The first low-side bias voltage VL1 may be equal to the second voltage difference (such as 2V). The initial low-side bias voltage VL0 may be equal to the first voltage difference (such as 1V).

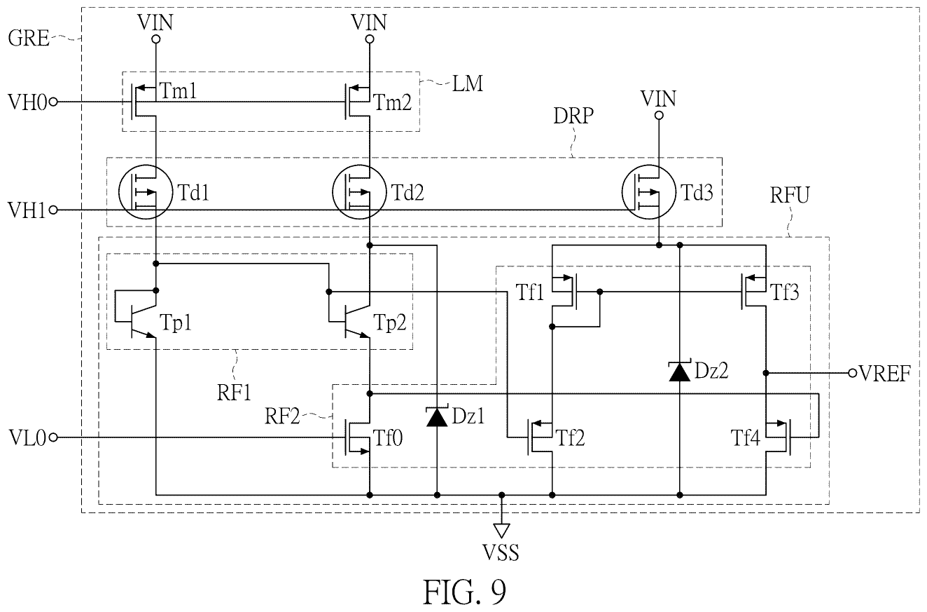

Reference is made to FIG. 9, which is a circuit diagram of a bandgap reference circuit of an overvoltage protection circuit according to a ninth embodiment of the present disclosure.

The overvoltage protection circuit of the present disclosure may include the bandgap reference circuit GRE shown in FIG. 9. The bandgap reference circuit GRE shown in FIG. 7 may be replaced with the bandgap reference circuit GRE shown in FIG. 9.

As shown in FIG. 9, the bandgap reference circuit GRE includes a reference voltage supplying circuit RFU. If necessary, the bandgap reference circuit GRE may further include a current limiting circuit LM shown in FIG. 9, a voltage drop receiving circuit DRP shown in FIG. 9 or a combination thereof.

As shown in FIG. 9, the current limiting circuit LM and the voltage drop receiving circuit DRP are connected between the input voltage VIN and the reference voltage level VSS, and configured to protect the reference voltage supplying circuit RFU.

The voltage drop receiving circuit DRP is configured to receive a part of a voltage drop between the input voltage VIN and the reference voltage level VSS for reducing a voltage drop received by the reference voltage supplying circuit RFU, thereby preventing the reference voltage supplying circuit RFU from being damaged due to overvoltage.

The current limiting circuit LM is configured to limit an amount of an input current that flows from the input voltage VIN through the voltage drop receiving circuit DRP to the reference voltage supplying circuit RFU, thereby preventing the reference voltage supplying circuit RFU from being damaged by an instantaneous large input current.

It is worth noting that, the reference voltage supplying circuit RFU includes a temperature sensing circuit RF1 and a reference voltage generating circuit RF2. The reference voltage generating circuit RF2 is connected to the temperature sensing circuit RF1. The temperature sensing circuit RF1 is configured to sense a temperature. The reference voltage generating circuit RF2 is configured to output the reference voltage VREF to the second input terminal such as the non-inverting input terminal of the comparator CMP1 according to the temperature sensed by the temperature sensing circuit RF1.

The temperature sensing circuit RF1 of the reference voltage supplying circuit RFU includes one or more temperature sensing components. The one or more temperature sensing components sense temperatures to output corresponding values. For example, as shown in FIG. 9, the temperature sensing circuit RF1 includes a first temperature sensing transistor Tp1 and a second temperature sensing transistor Tp2 that are bipolar transistors (BJTs). Voltages of the bipolar transistors (BJTs) are changed with a change in the temperature. When the temperature has a low temperature value, the voltages of the bipolar transistors (BJTs) have low voltage values. Conversely, when the temperature has a high temperature value, the voltages of the bipolar transistors (BJTs) have high voltage values.

For example, the reference voltage generating circuit RF2 includes an initial reference transistor Tf0, a first reference transistor Tf1, a second reference transistor Tf2, a third reference transistor Tf3 and a fourth reference transistor Tf4. If necessary, the reference voltage generating circuit RF2 may further include a Zener diode Dz1, a Zener diode Dz2 or a combination thereof.

The initial reference transistor Tf0, the first reference transistor Tf1, the second reference transistor Tf2, the third reference transistor Tf3 and the fourth reference transistor Tf4 form a current mirror circuit.

For example, the current limiting circuit LM includes a first current limiting transistor Tm1 and a second current limiting transistor Tm2. A first terminal of the first current limiting transistor Tm1 and a first terminal of the second current limiting transistor Tm2 are coupled to the input voltage VIN.

Control terminals of the first current limiting transistor Tm1 and the second current limiting transistor Tm2 of the current limiting circuit LM of the bandgap reference circuit GRE are coupled to the initial high-side bias voltage VH0 as shown in FIG. 9, are connected to an output terminal of the bias circuit BAS shown in FIG. 7 and receive the initial high-side bias voltage VH0 from the output terminal of the bias circuit BAS, or are connected to the initial high-side bias node of the bias circuit BAS and receive the initial high-side bias voltage VH0 from the initial high-side bias node shown in FIG. 8.

For example, the voltage drop receiving circuit DRP includes a first voltage receiving transistor Td1, a second voltage receiving transistor Td2 and a third voltage receiving transistor Td3.

A first terminal of the first voltage receiving transistor Td1 is connected to a second terminal of the first current limiting transistor Tm1. A first terminal of the second voltage receiving transistor Td2 is connected to a second terminal of the second current limiting transistor Tm2. A control terminal of the first voltage receiving transistor Td1, a control terminal of the second voltage receiving transistor Td2 and a control terminal of the third voltage receiving transistor Td3 as shown in FIG. 9 are coupled to the first high-side bias voltage VH1 shown in FIG. 9, are connected to the output terminal of the bias circuit BAS shown in FIG. 7 and receive the first high-side bias voltage VH1 from the output terminal of the bias circuit BAS, or are connected to the first high-side bias node of the bias circuit BAS shown in FIG. 8 and receive the first high-side bias voltage VH1 from the first high-side bias node.

A second terminal of the first voltage receiving transistor Td1 is connected to a first terminal and a control terminal of the first temperature sensing transistor Tp1 of the temperature sensing circuit RF1. A second terminal of the second voltage receiving transistor Td2 is connected to a first terminal of the second temperature sensing transistor Tp2 of the temperature sensing circuit RF1. A second terminal of the third voltage receiving transistor Td3 is connected to a first terminal of the first reference transistor Tf1 and a first terminal of the third reference transistor Tf3.

A second terminal of the first temperature sensing transistor Tp1 is coupled to the reference voltage level VSS.

A control terminal of the second temperature sensing transistor Tp2 is connected to a node between the first terminal of the first temperature sensing transistor Tp1 and the second terminal of the first voltage receiving transistor Td1. A second terminal of the second temperature sensing transistor Tp2 is connected to a first terminal of the initial reference transistor Tf0. A second terminal of the initial reference transistor Tf0 is coupled to the reference voltage level VSS.

A control terminal of the initial reference transistor Tf0 of the reference voltage supplying circuit RFU shown in FIG. 9 is coupled to the initial low-side bias voltage VL0 shown in FIG. 9, is connected to the output terminal of the bias circuit BAS shown in FIG. 7 and receives the initial low-side bias voltage VL0 from the output terminal of the bias circuit BAS, or is connected to the initial low-side bias node of the bias circuit BAS shown in FIG. 8 and receives the initial low-side bias voltage VL0 from the initial low-side bias node. The initial reference transistor Tf0 may operate in a linear region and may have a very high impedance.

A cathode of the Zener diode Dz1 is connected to the first terminal of the second temperature sensing transistor Tp2. An anode of the Zener diode Dz1 is coupled to the reference voltage level VSS.

A control terminal of the second reference transistor Tf2 is connected to the node between the first terminal of the first temperature sensing transistor Tp1 and the second terminal of the first voltage receiving transistor Td1. The first terminal of the first reference transistor Tf1 and the first terminal of the third reference transistor Tf3 are connected to the second terminal of the third voltage receiving transistor Td3. A control terminal of the third reference transistor Tf3 is connected to a control terminal and a second terminal of the first reference transistor Tf1.

A first terminal of the second reference transistor Tf2 is connected to the control terminal and the second terminal of the first reference transistor Tf1. A second terminal of the second reference transistor Tf2 and a second terminal of the fourth reference transistor Tf4 are coupled to the reference voltage level VSS.

A first terminal of the fourth reference transistor Tf4 is connected to a second terminal of the third reference transistor Tf3. A control terminal of the fourth reference transistor Tf4 is connected to a node between the first terminal of the initial reference transistor Tf0 and the second terminal of the second temperature sensing transistor Tp2.

A cathode of the Zener diode Dz2 is connected to the first terminal of the first reference transistor Tf1 and the first terminal of the third reference transistor Tf3. An anode of the Zener diode Dz2 is coupled to the reference voltage level VSS.

A node between the first terminal of the fourth reference transistor Tf4 and the second terminal of the third reference transistor Tf3 in the reference voltage supplying circuit RFU of the bandgap reference circuit GRE is used as the output terminal of the bandgap reference circuit GRE. The output terminal of the bandgap reference circuit GRE shown in FIG. 9 is connected to the second input terminal such as the non-inverting input terminal of the comparator CMP1 shown in FIG. 7, and supplies the reference voltage level VSS to the second input terminal such as the inverting non-input terminal of the comparator CMP1.

It is worth noting that, the overvoltage protection circuit of the present disclosure includes the bandgap reference circuit GRE shown in FIG. 9. The bandgap reference circuit GRE stably supplies the reference voltage VREF having a fixed voltage value to the second input terminal such as the non-inverting input terminal of the comparator CMP1 shown in FIG. 6 or FIG. 7 at any ambient temperature. Therefore, in the overvoltage protection circuit of the present disclosure, the main transistor Q2 is switched stably and appropriately, which is not affected by the ambient temperature. As a result, the output voltage VOUT of the second terminal of the main transistor Q2 is clamped at an appropriate voltage value for cutting off the surge. Therefore, the output voltage VOUT of the second terminal of the main transistor Q2 is not increased to be higher than the working voltages of the overvoltage protection circuit of the present disclosure and the post-stage circuit such as the load connected thereto. The overvoltage protection circuit of the present disclosure is capable of stably supplying the output voltage VOUT having the appropriate voltage value to the load, thereby preventing the load from being damaged due to overvoltage.

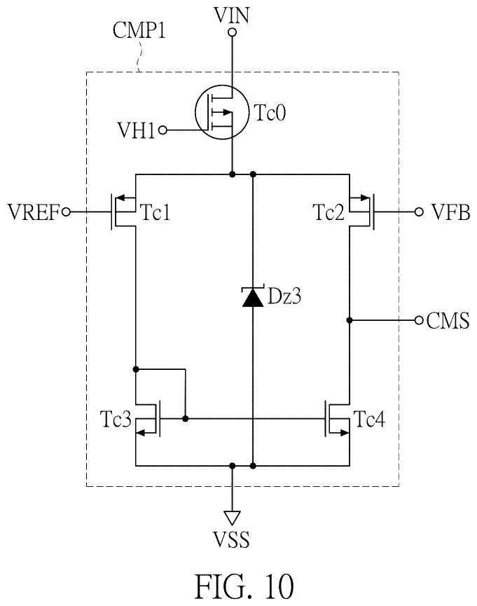

Reference is made to FIG. 10, which is a circuit diagram of a comparator of an overvoltage protection circuit according to a tenth embodiment of the present disclosure.

The overvoltage protection circuit of the present disclosure includes the comparator CMP1 shown in FIG. 10. The comparator CMP1 shown in FIG. 7 may be replaced with the comparator CMP1 shown in FIG. 10.

As shown in FIG. 10, the comparator CMP1 includes an initial comparison transistor Tc0, a first comparison transistor Tc1, a second comparison transistor Tc2, a third comparison transistor Tc3 and a fourth comparison transistor Tc4. If necessary, the comparator CMP1 may further include a Zener diode Dz3.

A first terminal of the initial comparison transistor Tc0 is connected to the input voltage VIN. A control terminal of the initial comparison transistor Tc0 inside the comparator CMP1 shown in FIG. 10 is connected to the bias circuit BAS shown in FIG. 7 and receives the first high-side bias voltage VH1 from the bias circuit BAS, or is connected to the first high-side bias node of the bias circuit BAS shown in FIG. 8 and receives the first high-side bias voltage VH1 from the first high-side bias node.

A first terminal of the first comparison transistor Tc1 is connected to a second terminal of the initial comparison transistor Tc0. A control terminal of the first comparison transistor Tc1 inside the comparator CMP1 shown in FIG. 10 is used as the second input terminal such as the non-inverting input terminal of the comparator CMP1, and is connected to the bandgap reference circuit GRE shown in FIG. 7 and receives the reference voltage VREF from the bandgap reference circuit GRE.

As shown in FIG. 10, a first terminal of the second comparison transistor Tc2 inside the comparator CMP1 is connected to the second terminal of the initial comparison transistor Tc0. A control terminal of the second comparison transistor Tc2 is used as the first input terminal such as the inverting input terminal of the comparator CMP1. The control terminal of the second comparison transistor Tc2 shown in FIG. 10 is connected to an output terminal of the voltage dividing circuit DIV (that is a feedback node between the second terminal of the first voltage dividing resistor Rd1 and the first terminal of the second voltage dividing resistor Rd2) shown in FIG. 6 or FIG. 7, and obtains the feedback voltage VFB from the output terminal of the voltage dividing circuit DIV.

A first terminal and a control terminal of the third comparison transistor Tc3 are connected to a second terminal of the first comparison transistor Tc1. A second terminal of the third comparison transistor Tc3 is coupled to the reference voltage level VSS.

A first terminal of the fourth comparison transistor Tc4 is connected to a second terminal of the second comparison transistor Tc2. A control terminal of the fourth comparison transistor Tc4 is connected to the control terminal of the third comparison transistor Tc3. A second terminal of the fourth comparison transistor Tc4 is coupled to the reference voltage level VSS.

A cathode of the Zener diode Dz3 is connected to the second terminal of the initial comparison transistor Tc0. An anode of the Zener diode Dz3 is coupled to the reference voltage level VSS.

A node between the first terminal of the fourth comparison transistor Tc4 and the second terminal of the second comparison transistor Tc2 inside the comparator CMP1 shown in FIG. 10 is used as the output terminal of the comparator CMP1, and is connected to the control terminal of each of the plurality of array transistors Ta shown in FIG. 7.

It is worth noting that, the overvoltage protection circuit of the present disclosure includes the first resistance circuit RES10, RES11, RES12 or RES13 and the second resistance circuit RES20, RES21, RES22, RES23 or RES24 for the main transistor Q2 or Q1. When the output voltage VOUT of the overvoltage protection circuit of the present disclosure is instantaneously increased to a high voltage value, the output voltage VOUT is clamped to fall within the working voltage ranges of the overvoltage protection circuit of the present disclosure and the post-stage circuit such as the load connected thereto.

In comparison with a conventional overvoltage protection circuit, the comparator CMP1 of the overvoltage protection circuit of the present disclosure does not need to have a high frequency bandwidth and a fast response. Therefore, the comparator CMP1 of the overvoltage protection circuit of the present disclosure only needs to be made of low cost materials. Only a small number of circuit components need to be disposed inside the comparator CMP1 of the overvoltage protection circuit of the present disclosure. That is, under the condition that the cost and an occupied space of the comparator CMP1 in the overvoltage protection circuit of the present disclosure are reduced, an effect of preventing the overvoltage protection circuit of the present disclosure and the post-stage circuit connected thereto from being damaged due to overvoltage is achieved.

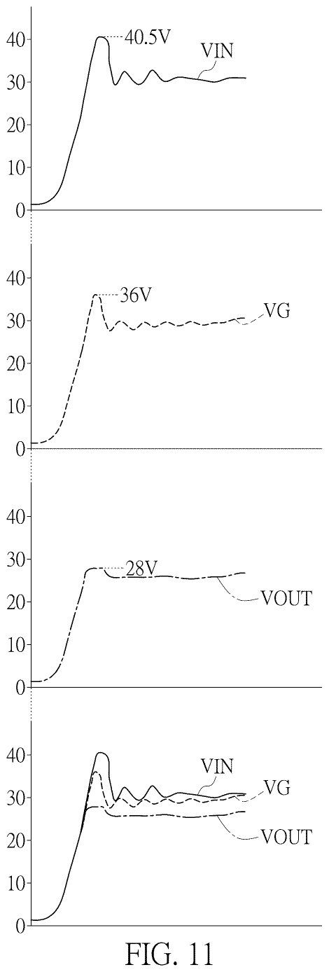

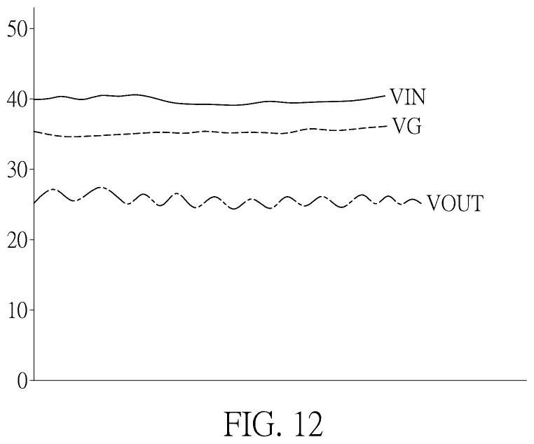

Reference is made to FIG. 11 and FIG. 12, which are waveform diagrams of signals of the overvoltage protection circuit according to the first to tenth embodiments of the present disclosure.

When the input voltage VIN of the overvoltage protection circuit of the present disclosure is instantaneously increased to a high voltage value (such as 40.5V shown in FIG. 11 and FIG. 12), a surge is generated in the voltage VG (such as 36V shown in FIG. 11 and FIG. 12) of the control terminal of the main transistor Q1 or Q2. At this time, the output voltage VOUT of the overvoltage protection circuit (that is the voltage of the source terminal of the main transistor Q1 or Q2) of the present disclosure is quickly clamped, for example, at 28V shown in FIG. 11 and FIG. 12. As a result, the voltages of the overvoltage protection circuit of the present disclosure and the post-stage circuit connected thereto do not exceed their rated voltages. Therefore, the overvoltage protection circuit of the present disclosure and the post-stage circuit are prevented from being damaged.

In conclusion, the present disclosure provides the overvoltage protection circuit. When a surge or an instantaneous high voltage value is generated in an output voltage of a circuit component inside a vehicle due to load dump, coupling between a plurality of wires of a wiring harness of an input power source, a surge in a power grid, lightning strike or other conditions in various applications, the output voltage of the overvoltage protection circuit of the present disclosure is clamped instantly. Therefore, the circuit component of the vehicle is not increased to be higher than its rated voltages, thereby preventing the circuit component from being damaged. Furthermore, an inductor having a large inductance, a surge protection device (SPD) and a transient voltage suppressor (TVS) are included in the conventional overvoltage protection circuit, but not included in the overvoltage protection circuit of the present disclosure. Therefore, heat that is generated by the overvoltage protection circuit of the present disclosure and an area of a space occupied by the overvoltage protection circuit of the present disclosure are much less than that of the conventional overvoltage protection circuit.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An overvoltage protection circuit, comprising:
a main transistor, wherein a first terminal of the main transistor is coupled to an input voltage, and a second terminal of the main transistor is used as an output terminal of the overvoltage protection circuit;
a first resistance circuit, wherein the first resistance circuit has a first resistance, and a first terminal of the first resistance circuit is connected to the first terminal of the main transistor; and
a second resistance circuit, wherein the second resistance circuit has a second resistance, a first terminal of the second resistance circuit is connected to a second terminal of the first resistance circuit, and a second terminal of the second resistance circuit is coupled to a reference voltage level;
wherein a control node between the first terminal of the second resistance circuit and the second terminal of the first resistance circuit is connected to a control terminal of the main transistor.

2. The overvoltage protection circuit according to claim 1, wherein the first resistance circuit includes a resistor.

3. The overvoltage protection circuit according to claim 1, wherein the second resistance circuit includes a resistor.

4. The overvoltage protection circuit according to claim 1, wherein the first resistance circuit includes a first transistor, a first terminal of the first transistor is coupled to the input voltage, a second terminal of the first transistor is connected to the control terminal of the main transistor, and a control terminal of the first transistor is coupled to a first high-side bias voltage.

5. The overvoltage protection circuit according to claim 1, wherein the second resistance circuit includes a control-side transistor, a first terminal of the control-side transistor is connected to the control terminal of the main transistor, a second terminal of the control-side transistor is coupled to the reference voltage level, and a control terminal of the control-side transistor is coupled to a first low-side bias voltage.

6. The overvoltage protection circuit according to claim 1, wherein the second resistance circuit includes:
a resistance component, wherein a first terminal of the resistance component is connected to the control terminal of the main transistor;
a transistor circuit, wherein the transistor circuit includes at least one array transistor, a first terminal of the at least one array transistor is connected to a second terminal of the resistance component, a second terminal of the at least one array transistor is coupled to the reference voltage level, and a control terminal of the at least one array transistor is coupled to a switching control voltage; and
a bypass switch, wherein a first terminal of the bypass switch is connected to the second terminal of the resistance component, a second terminal of the bypass switch is coupled to the reference voltage level, and a control terminal of the bypass switch is coupled to a variable instruction voltage.

7. The overvoltage protection circuit according to claim 6, wherein the resistance component includes:
a control-side transistor, wherein a first terminal of the control-side transistor is connected to the control terminal of the main transistor, and a control terminal of the control-side transistor is coupled to a first low-side bias voltage.

8. The overvoltage protection circuit according to claim 6, further comprising:
a comparator, wherein a first input terminal of the comparator is connected to the second terminal of the main transistor, a second input terminal of the comparator is coupled to a reference voltage, and an output terminal of the comparator is connected to the control terminal of the at least one array transistor.

9. The overvoltage protection circuit according to claim 8, further comprising:
a voltage dividing circuit, wherein the voltage dividing circuit includes a first voltage dividing resistor and a second voltage dividing resistor, a first terminal of the first voltage dividing resistor is connected to the second terminal of the main transistor, a second terminal of the first voltage dividing resistor is connected to a first terminal of the second voltage dividing resistor, a second terminal of the second voltage dividing resistor is coupled to the reference voltage level, and a feedback node between the second terminal of the first voltage dividing resistor and the second terminal of the second voltage dividing resistor is connected to the first input terminal of the comparator.

10. The overvoltage protection circuit according to claim 8, wherein the comparator includes:
an initial comparison transistor, wherein a first terminal of the initial comparison transistor is coupled to the input voltage, and a control terminal of the initial comparison transistor is coupled to a first high-side bias voltage;
a first comparison transistor, wherein a first terminal of the first comparison transistor is connected to a second terminal of the initial comparison transistor, and a control terminal of the first comparison transistor is used as the second input terminal of the comparator;
a second comparison transistor, wherein a first terminal of the second comparison transistor is connected to the second terminal of the initial comparison transistor, and a control terminal of the second comparison transistor is used as the first input terminal of the comparator;
a third comparison transistor, wherein a first terminal and a control terminal of the third comparison transistor are connected to a second terminal of the first comparison transistor, and a second terminal of the third comparison transistor is coupled to the reference voltage level; and
a fourth comparison transistor, wherein a first terminal of the fourth comparison transistor is connected to a second terminal of the second comparison transistor, a control terminal of the fourth comparison transistor is connected to a control terminal of the third comparison transistor, and a second terminal of the fourth comparison transistor is coupled to the reference voltage level;
wherein a node between the first terminal of the fourth comparison transistor and the second terminal of the second comparison transistor is used as the output terminal of the comparator.

11. The overvoltage protection circuit according to claim 10, wherein the comparator further includes:
a Zener diode, wherein a cathode of the Zener diode is connected to the second terminal of the initial comparison transistor, and an anode of the Zener diode is coupled to the reference voltage level.

12. The overvoltage protection circuit according to claim 8, further comprising:
a bandgap reference circuit connected to the second input terminal of the comparator, and configured to supply the reference voltage to the second input terminal of the comparator.

13. The overvoltage protection circuit according to claim 12, wherein the bandgap reference circuit includes a reference voltage supplying circuit, and the reference voltage supplying circuit includes:
a first temperature sensing transistor, wherein a first terminal of the first temperature sensing transistor is coupled to the input voltage and connected to a control terminal of the first temperature sensing transistor, and a second terminal of the first temperature sensing transistor is coupled to the reference voltage level;
a second temperature sensing transistor, wherein a first terminal of the second temperature sensing transistor is coupled to the input voltage, and a control terminal of the second temperature sensing transistor is connected to the first terminal of the first temperature sensing transistor;
an initial reference transistor, wherein a first terminal of the initial reference transistor is connected to a second terminal of the second temperature sensing transistor, a second terminal of the initial reference transistor is coupled to the reference voltage level, and a control terminal of the initial reference transistor is coupled to an initial low-side bias voltage;
a first reference transistor, wherein a first terminal of the first reference transistor is coupled to the input voltage;
a second reference transistor, wherein a first terminal of the second reference transistor is connected to a second terminal and a control terminal of the first reference transistor, a second terminal of the second reference transistor is coupled to the reference voltage level, and a control terminal of the second reference transistor is connected to the control terminal of the second temperature sensing transistor;
a third reference transistor, wherein a first terminal of the third reference transistor is coupled to the input voltage, and a control terminal of the third reference transistor is connected to the control terminal of the first reference transistor; and
a fourth reference transistor, wherein a first terminal of the fourth reference transistor is connected to a second terminal of the third reference transistor, a second terminal of the fourth reference transistor is coupled to the reference voltage level, and a control terminal of the fourth reference transistor is connected to the first terminal of the initial reference transistor.

14. The overvoltage protection circuit according to claim 13, wherein the reference voltage supplying circuit further includes:
a Zener diode, wherein a cathode of the Zener diode is connected to the first terminal of the second temperature sensing transistor, and an anode of the Zener diode is coupled to the reference voltage level.

15. The overvoltage protection circuit according to claim 13, wherein the reference voltage supplying circuit further includes:
a Zener diode, wherein a cathode of the Zener diode is connected to the first terminal of the first reference transistor and the first terminal of the third reference transistor, and an anode of the Zener diode is coupled to the reference voltage level.

16. The overvoltage protection circuit according to claim 13, wherein the bandgap reference circuit further includes:
a current limiting circuit, wherein a first terminal of the current limiting circuit is coupled to the input voltage, and the current limiting circuit is configured to limit an amount of an input current that flows from the input voltage to the reference voltage supplying circuit.

17. The overvoltage protection circuit according to claim 16, further comprising:
a voltage drop receiving circuit connected to a second terminal of the current limiting circuit, and configured to receive a part of a voltage drop between an input terminal of the overvoltage protection circuit and the reference voltage level.

18. The overvoltage protection circuit according to claim 17, wherein the current limiting circuit includes a first current limiting transistor and a second current limiting transistor, and the voltage drop receiving circuit includes a first voltage receiving transistor, a second voltage receiving transistor and a third voltage receiving transistor;
wherein a first terminal of the first current limiting transistor and a first terminal of the second current limiting transistor are coupled to the input voltage, and a control terminal of the first current limiting transistor and a control terminal of the second current limiting transistor are coupled to an initial high-side bias voltage;
wherein a first terminal of the first voltage receiving transistor is connected to a second terminal of the first current limiting transistor, a first terminal of the second voltage receiving transistor is connected to a second terminal of the second current limiting transistor, and a first terminal of the third voltage receiving transistor is coupled to the input voltage;
wherein a second terminal of the first voltage receiving transistor is connected to the first terminal of the first temperature sensing transistor, a second terminal of the second voltage receiving transistor is connected to the first terminal of the second temperature sensing transistor, and a second terminal of the third voltage receiving transistor is connected to the first terminal of the first reference transistor and the first terminal of the third reference transistor;
wherein a control terminal of the first voltage receiving transistor, a control terminal of the second voltage receiving transistor and a control terminal of the third voltage receiving transistor are coupled to a first high-side bias voltage.

19. The overvoltage protection circuit according to claim 12, further comprising:
a bias circuit including:
a first startup transistor, wherein a first terminal and a control terminal of the first startup transistor are coupled to the input voltage;
a second startup transistor, wherein a first terminal of the second startup transistor is connected to the first terminal and the control terminal of the first startup transistor, and a second terminal of the second startup transistor is coupled to the reference voltage level;
a first bias transistor, wherein a first terminal of the first bias transistor is coupled to the input voltage;
a second bias transistor, wherein a first terminal of the second bias transistor is coupled to the input voltage
a third bias transistor, wherein a first terminal of the third bias transistor, a second terminal and a control terminal of the first bias transistor and a control terminal of the second bias transistor are connected to an initial high-side bias node, and the initial high-side bias voltage is at the initial high-side bias node;
a fourth bias transistor, wherein a first terminal of the fourth bias transistor is connected to a second terminal of the second bias transistor;
a fifth bias transistor, wherein a first terminal of the fifth bias transistor, a second terminal and a control terminal of the third bias transistor and a control terminal of the fourth bias transistor are connected to a first high-side bias node, and the first high-side bias voltage is at the first high-side bias node;
a sixth bias transistor, wherein a first terminal and a control terminal of the sixth bias transistor, a control terminal of the fifth bias transistor and a second terminal of the first startup transistor are connected to a first low-side bias node, and the first low-side bias voltage is at the first low-side bias node;
a seventh bias transistor, wherein a first terminal of the seventh bias transistor is connected to a second terminal of the fifth bias transistor, and a second terminal of the seventh bias transistor is coupled to the reference voltage level; and
an eighth bias transistor, wherein a first terminal and a control terminal of the eighth bias transistor, a second terminal of the sixth bias transistor, a control terminal of the seventh bias transistor and a control terminal of the second startup transistor are connected to an initial low-side bias node, the initial low-side bias voltage is at the initial low-side bias node, and a second terminal of the eighth bias transistor is coupled to the reference voltage level;
wherein the bandgap reference circuit is connected to the initial high-side bias node, the first high-side bias node, the first low-side bias node and the initial low-side bias node, and is configured to output the reference voltage according to the initial high-side bias voltage, the first high-side bias voltage, the first low-side bias voltage and the initial low-side bias voltage.

20. The overvoltage protection circuit according to claim 19, further comprising:
a resistor connected between the first terminal of the first startup transistor and the input voltage.
